(19) United States
(12) Patent Application Publication
(10) Pub. No.: US 2009/0067684 A1
(43) Pub. Date: Mar. 12, 2009

(54) Variable Resolution Biometric Sensor

(75) Inventor: Jean-Francois Mainguet, Grenoble (FR)

Correspondence Address: FISH & RICHARDSON P.C., PO BOX 1022, MINNEAPOLIS, MN, 55440-1022, US

(73) Assignee: ATMEL SWITZERLAND, Fribourg (CH)

(21) Appl. No.: 11/851,020

(22) Filed: Sep. 6, 2007

(51) Int. Cl. G06K 9/00

(52) U.S. Cl. 382/124

(57) ABSTRACT

A variable resolution biometric sensing device includes a sensor manufacture for sensing a biometric stimulus. The sensor device is configured to output data having a resolution selected from among at least two selectable output resolutions.

### BACKGROUND

This disclosure relates to sensing devices.

Sensing devices can include sensor manufactures that can transduce one form of energy into another, e.g., charged coupled devices, piezoelectric materials, or pyroelectric materials. Such sensing devices can include basic control circuitry (e.g., amplifiers, analog-to-digital converters, input/output circuitry, and the like) on device (e.g., on-chip). The data output by the sensing device can be processed by a processing device in communication with the sensing device.

Sensing devices for use in biometrics provide data output for use in human identification. For example, data output by a biometric sensing device can be provided to a processing device that processes the data received from the sensor device to reconstruct a fingerprint image and attempt to authenticate or identify the fingerprint. A biometric sensor device can include multiple sensing elements, where the use of additional elements increases an output resolution of the device. Increasing the output resolution can increase the accuracy of measurements based on the higher resolution output data. Processing the higher resolution output data, however, is generally more computationally expensive than processing lower resolution output. In applications where the desired accuracy does not require higher resolution output, using a high resolution sensor can introduce an unnecessary processing delay. Selecting a biometric sensing device with the proper resolution for a given application can therefore optimize the performance the system.

### SUMMARY

The disclosure herein relates to a biometric sensor device with variable resolution.

In an implementation, a variable resolution biometric sensing device includes a sensor manufacture for sensing a biometric stimulus. The sensor device can be configured to output data having a resolution selected from among two or more selectable output resolutions. The sensor device includes a number of data cells for reading a stimulus. Switching circuitry of the sensor device enables the selection of one of a plurality of resolution output modes. Output of two or more data cells can be combined in a low resolution mode, and the data cells can be read independently in a high resolution output mode.

The sensor manufacture can be integrated in a biometric sensing device configured to sense a biometric stimulus, such as the application of a fingerprint to the biometric sensing device. In an implementation, the sensor manufacture layer comprises a pyroelectric material.

Optional advantages and other advantages can be separately realized by the sensor device. For example, selecting a sensor device for a given system can be simplified in that a single device can be adjusted so as to provide the resolution and resulting processing demands appropriate for a given application. The sensor device can enable the design of systems utilizing multiple resolution output modes, for example, a fingerprint identification application that includes a faster, less accurate mode and a slower, high accuracy mode. In addition, manufacturers can reduce their product catalog by offering, for example, a multiple resolution mode sensor device instead of two single mode devices, or statically set the output mode of sensor devices at the time of manufacture to replace two or more catalog offerings.

Such example advantages, however, need not be realized in particular implementations.

### BRIEF DESCRIPTION OF THE DRAWINGS

FIG. 1 is a block diagram of an example sensing device.

FIG. 2 is a block diagram of an example data cell arrangement of the sensor manufacture.

FIGS. 3 and 4 are block diagrams of example data cell configurations defined within the sensor manufacture.

FIG. 5 is a block diagram of an example circuit for reading output of a sensor manufacture.

FIG. 6 is a block diagram of an example circuit for providing a low and high resolution output mode from four adjacent data cells of a sensor manufacture.

FIG. 7 is a block diagram of an example sensing device configuration for providing a low and high resolution output mode from four data cells of a sensor manufacture.

FIG. 8 is a block diagram of an example circuit for providing a low and high resolution output mode from two data cells in a column of a sensor manufacture.

FIG. 9 is a block diagram of an example circuit for providing a low and high resolution output mode from two data cells in a row of a sensor manufacture.

FIG. 10 is a block diagram of an example circuit for providing a low, medium, and high resolution output mode from sixteen data cells of a sensor manufacture.

FIG. 11 is a flowchart of an example method of statically setting an output resolution mode of a sensor device.

FIG. 12 is a flowchart of an example method of statically setting an output resolution mode of a sensor device based on testing results.

FIG. 13 is a flowchart of an example method of scanning a fingerprint based on a value of a resolution signal.

FIG. 14 is a flowchart of an example method of scanning a fingerprint based on a resolution signal input indicating a low resolution mode.

### DETAILED DESCRIPTION

### Example Sensing Device

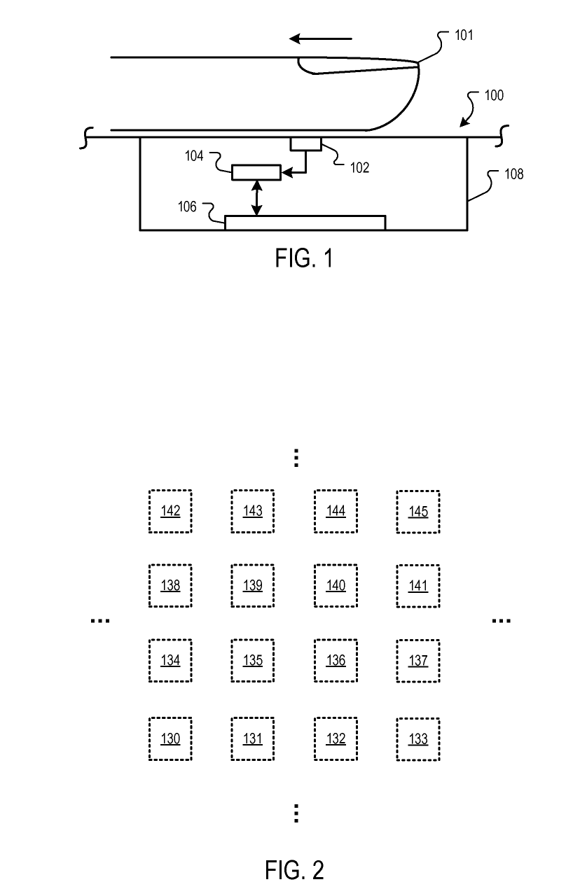

FIG. 1 is a block diagram of an example sensing device 100. The example sensing device 100 can be a biometric sensing device configured to sense a biometric stimulus, such as the swiping of a finger 101 to read a corresponding fingerprint, for example. The sensing device 100 can implement a different type of sensor, however.

The sensing device 100 can include a sensor manufacture 102 coupled to a processing circuit 104 and an input/output circuit 106. As the finger 101 is pressed and/or swiped on the sensor manufacture 102, the sensor manufacture 102 generates electrical signals based on a characteristic of the fingerprint on the finger 101. The source material of the sensor manufacture 102 can, for example, comprise a layer of polyvinylidene fluoride (PVDF), polyvinylidene fluoride, trifluoroethylene (PVDF-TrFE), polyvinylidene cyanide-vinyl acetate (PVDCN-VAc), or some other transducing material that can produce an electric charge in response to a physical stimulus, such as a biometric stimulus.

The electric signals output by the sensor manufacture 102 are processed by the processing circuit 104 and output through the input/output circuit 106 as biometric data to a processing device, such as a microprocessor executing filtering and recognition algorithms. The example sensing device 100 can generate multiple instances per second of, for example, biometric data, with each instance corresponding to a partial image of a fingerprint. The multiple instances of biometric data can be processed by the processing device to detect overlapping data and generate a complete image of the fingerprint of the finger 101.

In another implementation, the sensor manufacture 102 can be of such proportion to receive an entire fingerprint of the finger 101. In this implementation, the finger 101 can be held stationary against the sensor manufacture 102 and an image of the entire fingerprint can be generated from a single instance of biometric data. Other biometric data collection techniques can also be used.

### Example Data Cell Configurations

FIG. 2 is a block diagram of an example data cell arrangement of the sensor manufacture 102. Output from a cell can correspond to, for example, a pixel of a sensed fingerprint output. Cells 130-145 are arranged in a grid. The sensor manufacture 102 can include more or fewer cells than those shown. In various implementations, cells of the sensor manufacture 102 are defined by thermal sensitive cells, capacitive sensitive cells, optical cells, radio frequency field measurement cells, pressure sensitive cells, and/or ultrasound measurement cells.

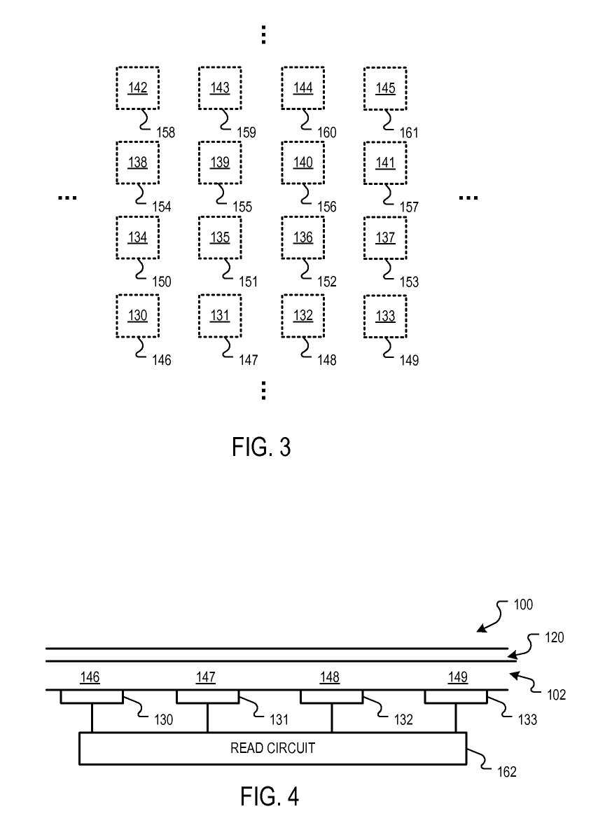

FIGS. 3 and 4 are block diagrams of example data cell configurations defined within the sensor manufacture 102 of the example sensing device 100. The sensor manufacture 102 can, for example, comprise a layer of pyroelectric material fabricated between an upper electrode 120 and a matrix array of lower electrodes as depicted by electrodes 146-161 in FIGS. 3 and 4. Corresponding data cells 130-145 are defined by each lower electrode 146-161 and the upper electrode 120. In one implementation, the upper electrode 120 can comprise a single electrode fabricated atop the sensor manufacture 102. In another implementation, the upper electrode 120 can comprise multiple electrodes fabricated atop the sensor manufacture 102, e.g., row electrodes, or column electrodes, or a plurality of electrodes corresponding to the electrodes 146-161. In yet another implementation, the sensor manufacture can comprise a single lower electrode and a plurality of upper electrodes that are, for example, distributed atop the sensor manufacture to define a plurality of data cells.

As shown in FIG. 3, cells can, for example, be arranged in rows and columns. The number of rows and columns can vary according to the particular implementation of the sensor device 100. For example, the sensor manufacture 102 can comprise a relatively few number or rows and multiple columns and be configured to provide overlapping sections of biometric data during a finger swipe. Alternatively, the sensor manufacture 102 can comprise multiple rows and columns and be configured to provide a single instance of biometric data for an entire fingerprint. In one implementation, the sensor manufacture 102 can be approximately 1.2 centimeters in width and approximately 0.4 millimeters in length, and can comprise 8 rows of electrodes, with each row comprising 232 electrodes. Other configurations can also be used.

A processing circuit 104, such as, for example, a read circuit 162, can be connected to the lower electrodes 146-161. In an implementation, the read circuit 162 can include switching circuitry for selecting one of plurality of output resolution modes of the sensing device.

### Example Switching Circuitry

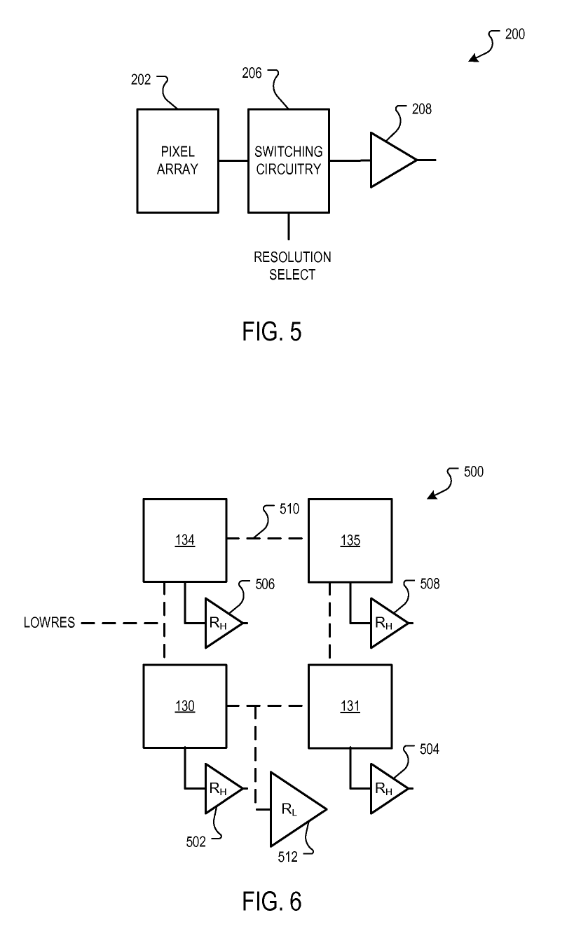

FIG. 5 is a block diagram of an example circuit for reading output of a sensor manufacture. Output of a cell array 202 is provided to switching circuitry 206. The switching circuitry 206 can include an input for selecting an output resolution mode of the sensing device. In response to the resolution selection, the switching circuitry selectively combines or isolates two or more data cells for reading and coupling to the output amplifier 208. The switching circuitry groups or isolates data cells of the sensor manufacture to vary the output resolution of the sensing device.

In response to the resolution selection, the switching circuitry selectively combines or isolates two or more data cells, for example the lower electrodes of FIG. 4 can be joined for reading and coupling to the output amplifier 208. In an implementation, each of the lower electrodes of the sensor manufacture is coupled to the switching circuitry.

FIG. 6 is a block diagram of an example circuit for providing a low and high resolution output mode from four adjacent data cells of a sensor manufacture. The data cells 130, 131, 134, and 135 are coupled to respective output amplifiers 502, 504, 506, and 508. Switching circuitry, represented by dashed lines 510, connects to the output of the four data cells, and can selectively combine the four data cells by, for example, selectively causing four respective electrodes to be electrically coupled. In an implementation, the output of combined data cells is summed.

In a high resolution mode, the switching circuitry keeps the four data cells separated by, for example, keeping four respective electrodes electrically isolated so that a respective independent electrical signal is read at each of the output amplifiers 502, 504, 506, and 508. In a low resolution mode, the switching circuitry combines the data cells by, for example, electrically coupling four respective electrodes such that a combined electrical signal is read at the output amplifier 512 that is, in effect, shared by the data cells 130, 131, 134, and 135. In an implementation, where a set of cells are combined (e.g., summed), any amplifier associated with one of the cells can be used to read the summed data. For example, the combined electrical signal is read by one of the output amplifiers 502, 504, 506, and 508 (instead of being read at the output amplifier 512). The amplifier used to read the summed signal can have input tolerances and gain characteristics suitable for the combined signal or have selectable modes of operation that are selected according to the current output resolution mode.

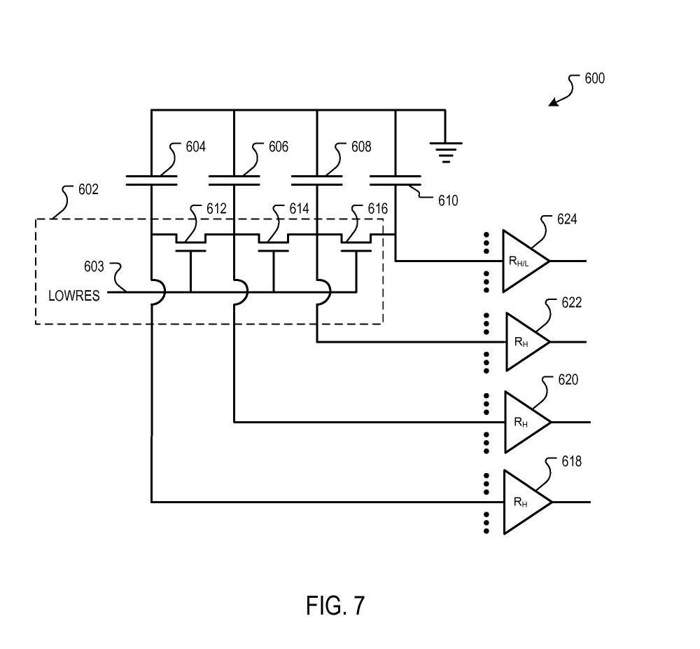

FIG. 7 is a block diagram of an example sensing device configuration 600 for providing a low and high resolution output mode from four data cells of a sensor manufacture. Switching circuitry 602 includes three gates 612, 614, 616, and an input 603. Four cells of a sensor manufacture are represented by the four capacitor devices 604, 606, 608, and 610 having respective output amplifiers 618, 620, 622, and 624. A charge accumulated on the capacitors can be proportional to, for example, the form of a fingerprint, sensed according to one or more of the previously described sensing techniques. Gate 612 connects the lower electrodes of capacitor devices 604 and 606. Gate 614 connects the lower electrodes of capacitor devices 606 and 608. Gate 616 connects the lower electrodes of capacitor devices 608 and 610.

In a high resolution mode the gates are switches in an open position. That is, the lower electrodes of the capacitor devices remain electrically isolated. In this mode, an independent electrical signal representative of sensor data obtained at the respective data cells is available at each of the output amplifiers 618, 620, 622, and 624. This mode provides a higher level of detail in its output, and thus includes four output values for processing.

In a low resolution mode the gates are switches in a closed position. The lower electrodes of the capacitor devices are electrically coupled. In this mode, a combined electrical signal representative of sensor data obtained at the four data cells is available at the output amplifiers 624. Output amplifier 624 is labeled as being capable of accepting the combined signal of the low resolution mode; however, in an implementation, the combined signal can be accepted at any of output amplifiers 618, 620, 622, and 624 if they have the proper input and gain characteristics. This mode provides one output value for processing, but provides a lower level of detail in its output.

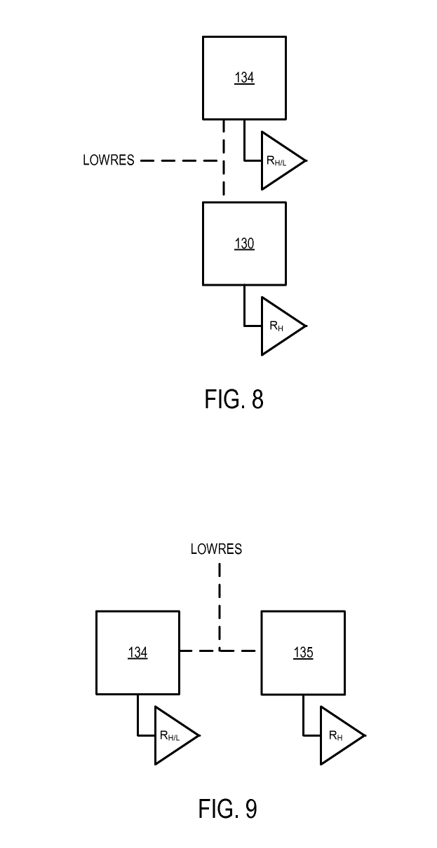

FIG. 8 is a block diagram of an example circuit for providing a low and high resolution output mode from two data cells in a column of a sensor manufacture. Data cells can be selectively combined in rows such as shown in FIG. 8 where adjacent data cells 130 and 134 are selectively coupled depending on an output resolution mode.

FIG. 9 is a block diagram of an example circuit for providing a low and high resolution output mode from two cells in a row of a sensor manufacture. Data cells can be selectively combined in columns such as shown in FIG. 9 where adjacent cells 134 and 135 are selectively coupled depending on an output resolution mode.

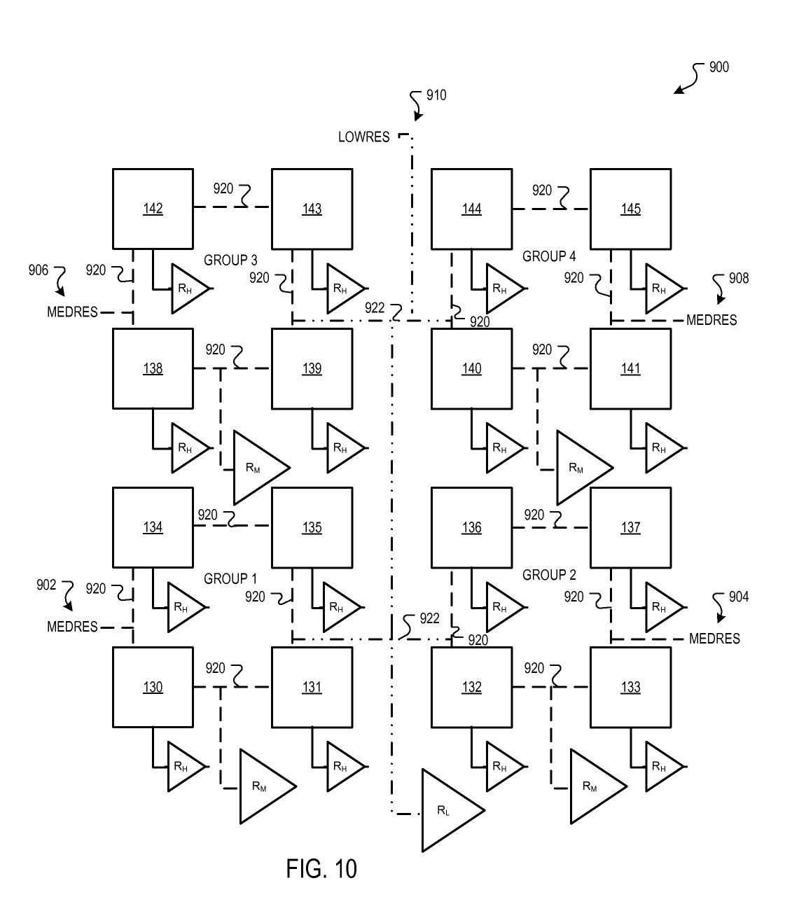

FIG. 10 is a block diagram of an example circuit for providing a low, medium, and high resolution output mode from sixteen data cells of a sensor manufacture. Sixteen data cells 130-145 are coupled to sixteen respective output amplifiers (labeled R_{H}). In a high resolution mode, each of the sixteen cells provides an independent electrical signal to their respective output amplifier R_{H}. The high resolution mode provides sixteen outputs.

Activating a medium resolution mode causes the medium resolution switching circuitry 902, 904, 906, and 908, represented by dashed line pattern 920, to electrically couple four groups of four adjacent cells to generate medium resolution outputs. In a medium resolution output mode, electrical signals from cells 130, 131, 134, and 135 are combined (group 1), as are cells 132, 133, 136, and 137 (group 2), cells 138, 139, 142, and 143 (group 3), and cells 140, 141, 144, and 145 (group 4). The combined electrical signals of the respective groups are coupled to output amplifiers R_{M}, and a medium resolution output of the sensor device is available at the output amplifiers R_{M}. In the medium resolution mode, each of the groups 1-4 provides an output for a total of four outputs. In an implementation, the combined electrical signals of the grouped cells are instead amplified by one of the amplifiers R_{H} in each group.

Activating a low resolution mode causes the low resolution switching circuitry 910 represented by the dashed line pattern 922, to electrically couple the four groups of four cells (sixteen cells total) of the medium resolution to generate a single low resolution output from the cells 130-145. In the low resolution mode, the four groups of four remain electrically coupled as in the medium resolution mode, and the low resolution switching circuitry further electrically couples the four groups. The combined electrical signals of the sixteen cells are coupled to the output amplifier R_{L}. In an implementation, the combined electrical signal can be amplified by one of the amplifiers R_{H}.

The configurations shown are examples, and other configurations are possible that provide additional output resolution modes from a sensor device.

In an implementation, a static resolution output mode of the sensor device is determined during a manufacturing process. A manufacturer of the sensor device can offer differing versions of the device that have resolution output modes statically set at the place of manufacture. For example, the manufacturer can offer a version of the sensor device that outputs data having a 250 dpi (dots per inch) resolution, a 375 dpi version, a 500 dpi version, and a 1000 dpi version, where the resolution mode is statically set at the factory before the sensor device is shipped to customers. The resolution mode of the sensor device can be statically set by establishing static electrical connections to an input of the switching circuitry. For example, two inputs to the switching circuitry can both be electrically coupled to a power source conductor of the sensor device (at a potential of +3 volts, for example) to set the sensor to a 1000 dpi mode. For example both inputs can be set to a binary ‘1’ (1,1).

### Example Methods

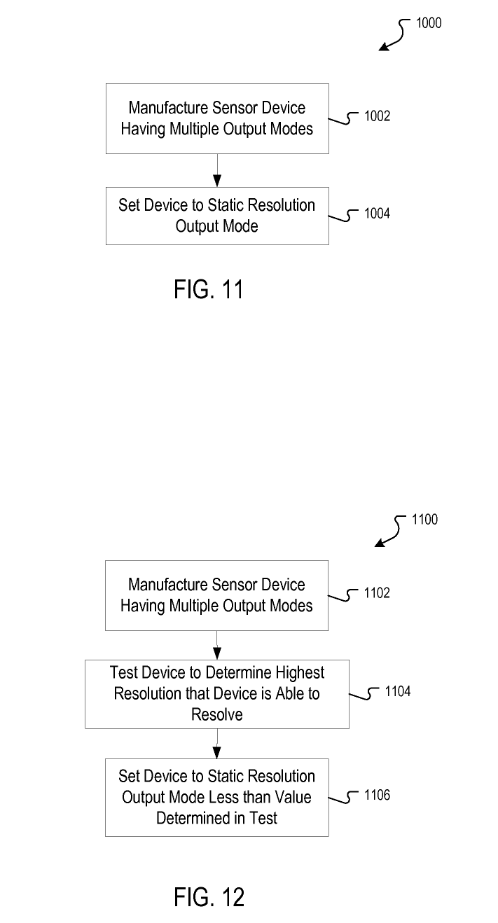

FIG. 11 is a flowchart of an example method of statically setting an output resolution mode of a sensor device. A sensor device having multiple resolution output modes is manufactured (1002). The device is statically set to one of the resolution output modes (1004).

In an implementation, sensor devices can be manufactured with electrical connections that facilitate the highest output resolution, and the connections can be later broken by, for example, laser trimming an area on a printed circuit board to place the sensor device in a lower resolution mode. Other resolution modes, for example, can be set using combinations of binary inputs to the switching circuitry—for example (1,0) for 500 dpi, (0,1) for 375 dpi, and (0,0) for 250 dpi.

In an implementation, sensor devices can be tested to determine a reliable output resolution, and the electrical connections to the switching circuitry can be altered based on the testing results to set the device to an output resolution mode consistent with the results of the test. For example, if a sensor device tests as being able to resolve a maximum dpi of 600, the electrical connections can be altered to set the device to a 500 dpi output mode.

FIG. 12 is a flowchart of an example method of statically setting an output resolution mode of a sensor device based on testing results. A sensor device having multiple resolution output modes is manufactured (1102). The device is tested to determine a maximum resolution that the device is able to resolve (1104). The device is set to a static resolution that is less than the maximum value determined in testing (1106). In an implementation the device is set the next device capable resolution mode that is lower than the maximum value determined in testing.

In an implementation, even if a manufacturer reaches a device yield where a high percentage of the devices produced are able to resolve the highest output resolution, sensor devices are statically set to lower resolution modes to provide a spectrum of available devices in a manufacturers catalog.

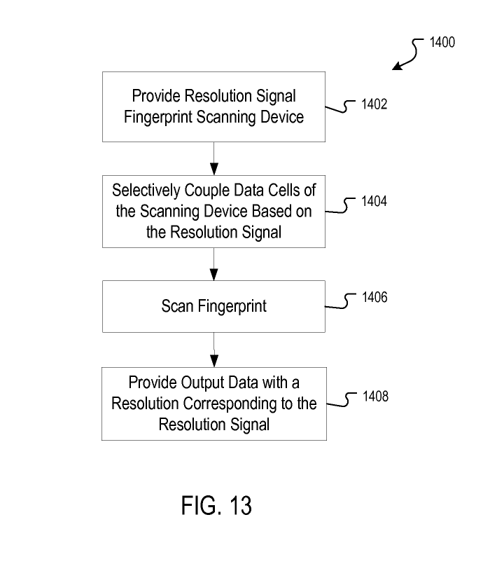

FIG. 13 is a flowchart of an example method 1400 of scanning a fingerprint based on a value of a resolution signal. A resolution signal is provided to a fingerprint scanning device (1402). The resolution signal can indicate, for example, one of a plurality of resolution modes of the fingerprint scanning device to be used in scanning a fingerprint. Data cells of the fingerprint scanning device are selectively coupled based on the value of the resolution signal (1404). For example, two or more data cells can be electrically coupled using switching circuitry based on a value of the resolution signal. A fingerprint is scanned at the fingerprint scanning device (1406). A fingerprint scan can be completed, for example, by a finger being swiped across a surface of the fingerprint scanning device. Alternatively, a scan can be made of a fingerprint placed and held in a static position on a surface of the fingerprint scanning device during the scan. Fingerprint scan output data is provided having a resolution corresponding to the resolution signal (1408).

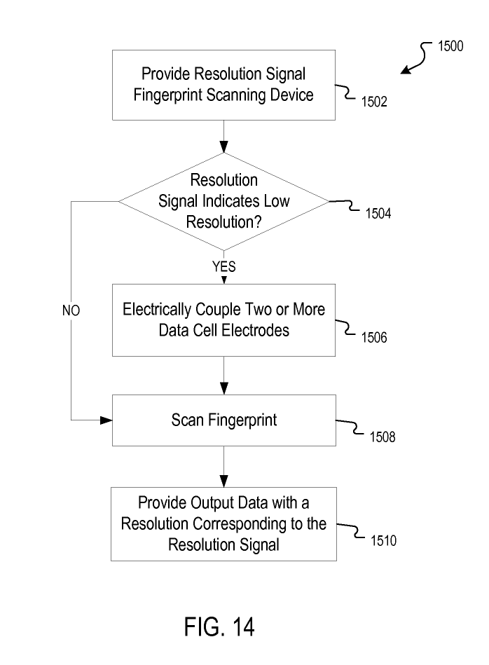

FIG. 14 is a flowchart of an example method 1500 of scanning a fingerprint based on a resolution signal input indicating a low resolution mode. A resolution signal is provided to a fingerprint scanning device (1502). The resolution signal can indicate, for example, one of a plurality of resolution modes of the fingerprint scanning device to be used in scanning a fingerprint. The resolution signal is read and checked to determine if the resolution signal indicates that a low resolution mode of the fingerprint scanning device is indicated (1504). If a low resolution mode is indicated, the electrodes of two of more data cells are electrically coupled (1506). Switching circuitry, can, for example, electrically couple the electrodes of groups of adjacent cells to combine fingerprint information read at the data cells. A fingerprint is scanned (1508), and fingerprint scan output data is provided having a resolution corresponding to the resolution signal (1510).

This written description sets forth the best mode of the invention and provides examples to describe the invention and to enable a person of ordinary skill in the art to make and use the invention. This written description does not limit the invention to the precise terms set forth. Thus, while the invention has been described in detail with reference to the examples set forth above, those of ordinary skill in the art may effect alterations, modifications and variations to the examples without departing from the scope of the invention.

What is claimed is:

1. An apparatus, comprising:
a sensor manufacture layer;
a plurality of electrodes connected to sensor manufacture layer, the plurality of electrodes spaced apart to define data cells in the sensor manufacture layer; and
switching circuitry configured to enable the selection of one of a plurality of resolution output modes.

2. The apparatus of claim 1, wherein:
the switching circuitry is configured to electrically couple at least two electrodes to combine respective data cells in a low resolution output mode.

3. The apparatus of claim 2, wherein:
the switching circuitry is further configured to electrically isolate the electrodes in a high resolution output mode.

4. The apparatus of claim 1, wherein the switching circuitry is configured to electrically isolate the electrodes in a high resolution output mode.

5. The apparatus of claim 1, wherein:
the sensor manufacture comprises a biometric sensing device configured to sense a biometric stimulus.

6. The apparatus of claim 5, wherein:
the biometric stimulus comprises an application of a fingerprint to the biometric sensing device.

7. The apparatus of claim 1, further comprising:
an upper surface, wherein the sensor manufacture layer defines first and second sides, the first side of the sensor manufacture layer connected to the upper surface, the plurality of electrodes connected to the second side of the sensor manufacture.

8. The apparatus of claim 1, wherein:
the sensor manufacture layer comprises a pyroelectric material.

9. The apparatus of claim 1, further comprising:
a plurality of output amplifiers coupled to the plurality of electrodes, the plurality of amplifiers configured to generate output signals based on electrical signals of the electrodes.

10. The apparatus of claim 9, wherein:
the switching circuitry is configured to electrically isolate each of the electrodes in a high resolution mode such that an independent electrical signal of each electrode is provided at a respective output amplifier.

11. The apparatus of claim 9, wherein:
the switching circuitry is configured to electrically couple at least two electrodes in a low resolution mode such that a combined electrical signal is provided to a shared output amplifier for generating a combined output signal.

12. The apparatus of claim 10, wherein:
the switching circuitry is configured to electrically couple at least two electrodes in a low resolution mode such that a combined electrical signal is provided to a shared output amplifier for generating a combined output signal.

13. The apparatus of claim 1, wherein:
the plurality of resolution output modes comprise at least three resolution output modes.

14. The apparatus of claim 1, wherein:
the switching circuitry is configured to electrically couple groups of two or more electrodes to combine respective data cells in one of the plurality of resolution output modes.

15. The apparatus of claim 1, wherein:
the sensor manufacture layer comprises a capacitive sensor array coupled to the plurality of electrodes and configured to generate electrical charges on the plurality of electrodes proportional to ridges and valleys of a fingerprint sensed by the array.

16. The apparatus of claim 1, further comprising:
a plurality of output amplifiers coupled to the plurality of electrodes, the plurality of amplifiers configured to generate output signals based on electrical signals of the electrodes, wherein:
the sensor manufacture layer comprises a pyroelectric sensor layer defining first and second sides; and
the plurality of electrodes being connected to the second side of the pyrolelectric sensor layer, the plurality of electrodes being spaced apart to define data cells in the pyroelectric sensor layer, the switching circuitry being coupled to the plurality of electrodes and the plurality of output amplifiers.

17. The apparatus of claim 16, further comprising:
an upper electrode layer, the plurality of electrodes comprising lower electrodes, the first side of the pyroelectric sensor layer being connected to the upper electrode layer; and
a processing circuit connected to the output amplifiers and configured to process the output signals of the amplifiers.

18. A method of producing a single resolution output mode fingerprint sensor device comprising:
manufacturing a multiple resolution output mode fingerprint sensor device; and
setting an output resolution mode of the fingerprint sensor device to a static mode.

19. The method of claim 18, further comprising:
determining a maximum resolvable resolution of the sensor device; and
wherein setting an output resolution mode of the fingerprint sensor device comprises setting the output resolution mode to an output mode having a resolution less than the maximum resolvable resolution.

20. A method, comprising:
providing a resolution signal to an input of a fingerprint scanning device;
scanning fingerprint information at a plurality of data cells of the fingerprint scanning device;
selectively coupling electrodes of at least two data cells of the plurality of data cells based on the resolution signal; and
providing fingerprint output data at an output of the fingerprint scanning device, the output data having a resolution based on the resolution signal.

21. The method of claim 20, wherein:
the resolution signal indicates a low resolution mode; and
the switching circuitry electrically couples the at least two data cells in the low resolution mode.

22. The method of claim 20, wherein:
the resolution signal indicates a high resolution mode; and
the switching circuitry electrically isolates the at least two data cells in the high resolution mode.
